(19) United States
(12) Patent Application Publication
(10) Pub. No.: US 2020/0122175 A1
(43) Pub. Date: Apr. 23, 2020

(54) SYSTEM FOR MONITORING A SHOWER STREAM

(71) Applicants: Greg Floyd, Austin, TX (US); Rahul Verma, Austin, TX (US); Cameron Meziere, Austin, TX (US); Emily Hood, Cypress, TX (US); Ian Howard, San Marcos, TX (US); Michael Mayes, Spicewood, TX (US)

(72) Inventors: Greg Floyd, Austin, TX (US); Rahul Verma, Austin, TX (US); Cameron Meziere, Austin, TX (US); Emily Hood, Cypress, TX (US); Ian Howard, San Marcos, TX (US); Michael Mayes, Spicewood, TX (US)

(21) Appl. No.: 16/371,303

(22) Filed: Apr. 1, 2019

Related U.S. Application Data
(60) Provisional application No. 62/748,047, filed on Oct. 19, 2018.

(51) Int. Cl. B05B 12/12; E03C 1/05; B05B 1/18; B05B 1/30

(52) U.S. Cl. CPC B05B 12/122; B05B 1/30; B05B 1/18; E03C 1/057

(57) ABSTRACT

A motion-activated shower head adapter that saves water, energy and money and records the savings with a software analytics dashboard. The adapter allows cold water flow out when the shower is first turned on, and shuts off water flow once the water is heated. When the presence of the user is automatically detected, the shower flow resumes.

### CROSS REFERENCE TO RELATED APPLICATIONS

This application claims benefit of U.S. Provisional Patent Application No. 62/748,047, filed Oct. 19, 2018, the disclosure of which is incorporated herein by reference.

### FIELD OF INVENTION

The present invention is directed to reducing shower water waste through use of an ultrasonic sensor, analytics software and a wi-fi system connected to hardware devices.

### BACKGROUND AND SUMMARY OF THE INVENTION

The fundamental problem to be addressed is called what is known in the hotel industry as Shower Warm-up Waste. Lawrence Berkeley National Lab's study shows that 70% of bathers leave their showers unattended and 52% of bathers multitask while their shower warms up. This leaves their showers to run unoccupied long after the water is warm, almost 2 minutes on average, for every shower in the US. Common examples of multi-tasking activities while the shower warms up include brushing one's teeth or using the bathroom.

This invention provides a cost savings in less than one year and return of a 400% 5-year return over time to the customer. Besides the savings, the product provides an analytics platform that monitors and reports shower maintenance requirements. The service is implemented with a combination of cloud-based analytics software and internet of things wifi connected hardware devices. The software consists of a user interface dashboard for the hotel owner (customer/user) to monitor the precise utility cost savings over the previous months and view the projected utility cost savings for the next month.

The hardware device consists of a motion-sensitive valve that stays open to allow the water to warm-up then closes to stop waste water flow if the bather has not yet entered the shower. Once the bather enters the shower, the motion sensor detects their presence and resumes the flow of water automatically. Absolutely no change to guest shower behavior is required. The hardware device has a temperature sensor to record and monitor shower temperature, and a wifi adapter to connect with the analytics software in the cloud. The innovation proposed in this grant is the novel assembly of the mature sensor technologies and its integration with a cloud based service. This innovative application in hotel showers saves cost and makes commercial buildings more energy and water efficient.

In addition to strong commercialization impact, the invention will have extremely large positive environmental impacts. The EPA claims that over 20% of hot water is wasted to shower warm-up waste. This system will eliminate that waste and upon successful commercial adoption at scale will save cities and states enormous amounts of water or energy Eliminating shower warm-up waste amounts to at least 200 billion gallons of water and at least one trillion kWh of energy saved in the U.S. each year. The total cost of this waste is over $5 trillion dollars every year in the U.S. alone. Further, the development of a novel PIR sensor resilient to steam, and a utility analytics platform will have very broad commercial, scientific and technological applications outside of this application of the technology.

### DETAILED DESCRIPTION OF THE INVENTION

There are currently two existing solutions to the problem of shower waste water: low flow shower heads and re-circulating water heating systems.

Low flow shower heads can reduce the amount of water and energy that a shower consumes. However, studies from United Utilities show that people soundly reject the adoption of showers with flow rates below 2.2 gallons per minute claiming a decrease in shower enjoyment and perceived sense of inadequate water pressure to properly bathe (Critchley & Phipps, 2007).

Recirculating water pumps to speed up hot water delivery to their showers. However, a study presented at the ACCC conference shows that there is no correlation between how fast shower water warms up and how long it takes the bather to enter the shower. While they increase the system efficiency of water heating systems, they simply do not address “behavioral waste” (Klein & Sherman, 2016).

This system operates under three main states: (1) Shower running, (2) Communication, and (3) Deep sleep. When the user turns on the shower, the micro controller comes into action and runs our utility saving algorithm. The temperature sensor monitors changes in water temperature and works in conjunction with the proximity sensor to actuate the flow valve. An average shower lasts for about 9 minutes, the length of the shower running mode. During the communications mode, closer to the end of the shower, the Wi-Fi adapter connects with the hotel Wi-Fi network for about 1 minute, to transmit data. After the shower and communication, the adapter goes into a deep sleep mode to minimize the energy consumption. A water switch works as a wake-up sensor to bring the adapter to running condition when a user turns on the shower. The current prototype uses approximately 11 mAh per day.

The valve controller consumes almost 37% of the total energy consumption in day. Replacing a new valve controller in version brought down the total energy consumption from 200 mAh to 11 mAh. As part of our research efforts, we will be testing new controllers with lower energy requirements. The second highest energy consumer is the micro-controller, in deep sleep mode. The ARM based chip being used in the current prototype is not optimized for deep sleep, low power mode. In our future versions, we'll be using ultra low power microcontroller, that draws less than 1 IJA current during deep sleep mode. This alone, will bring down the energy consumption by over 2 mAh (Albus, Valenzuela, & Buccini, 2009).

After updating the microcontroller with a low power chip, the total energy consumption will come down to 9 mAh. At 9 mAh, the 2200 mAh battery in the current prototype, will last 8 months. A hotel shower is used 1.6 times per day on average for an occupied hotel room. Over time, the energy consumption for extra showers balances out with idle time when rooms are not occupied. Average occupancy rate in American hotels is approximately 68% (STR Global, 2017). One of our pilot partners has mentioned in his support letter that a 6 month battery life is sufficient for their hotels. The regular maintenance staff can change the batteries when needed. Our cloud platform will show battery state and alert the staff in case of low battery.

Three sensor technologies were evaluated for suitability of sensing human occupancy in a shower. The three sensor types tested were: 1. Passive-Infrared (PIR), 2. Time of Flight (TOF), and 3. Ultrasonic. The ideal sensor for this application is immune to water, large temperature variations, and steam and reliably detects a presence of a human in a wide variety of shower environments (Song, Choi, & Lee, 2008) (Kolb, Barth, Koch, & Larsen, 2009) (Marioli, 1992).

### Proximity Infrared Sensor

The HC-SR501 PIR sensor was used on the Shower Stream Prototype. This sensor is a differential passive-infrared sensor. All objects with a temperature above absolute zero emit radiation. This sensor detects the amount of this radiation that falls upon two separate sensing areas.

By using a Fresnel lens, the two sensor areas can detect changes in the emitted radiation level of an area. Motion is detected when the level of one sensor element changes relative to the other. The average level of radiation detected across both elements is canceled out. This allows the sensor to be immune to changes in the environment where everything in its field of view has an increased or decreased radiation level. It is only sensitive to the differences between the two sensor areas.

### Time of Flight Sensor

The second sensor we tested, was an ST Microelectronics VL53LOX sensor. This sensor emits infra-red radiation and measures how long it takes for the emitted signal to bounce off an object and come back to the sensor. This is called a Time of Flight (TOF) measurement. This sensor has a measurement range of—3 feet. The emitter wavelength is 940 nm (infra-red). The field of view is 25 degrees. The detection spot size is about 16″ diameter at a distance of 3 feet from the sensor. We used an evaluation board for the VL53LOX sensor for our testing. We tested performance with no water, cold water, and hot water. The sensor works well with no water and with cold water. But, hot water produces false positives.

### Ultrasonic Sensor

The last sensor that we tested was an ultrasonic sensor. The CB uses two US1440 transducers. One was used as an emitter and the other as a detector. This sensor is waterproof, uses a frequency of 40 KHz and has a range of about 9 feet. The field of view is 70 degrees and the operating temperature is −40 to 80 C. The ultrasonic sensor uses sound waves above the human hearing range. The sensor can be used to measure distance to an object by measuring how long it takes for sound to travel from the emitter, bounce of an object, and return to the detector. For this application, a single transducer can be used as both the emitter and detector since the detection range is more than 6″ away from the transducer (Marioli, 1992).

Initial testing indicates that this sensor is not sensitive to hot water or steam and that it would work well for this application.. The different measurements over time are shown on the horizontal axis. This chart shows that the sensor readings remained stable when the hot water was turned on and steam filled the room. The data on the far right of the chart shows that the sensor functioned as expected and reported the distance of an arm as it was moved back and forth in the steam filled room.

The following Table 1 summarizes the characteristics of the sensors that were tested. Of the three sensor technologies tested, the ultrasonic sensor performed the best and looks like it will be a good fit for this application.

TABLE 1
Summary of preliminary sensor tests

| | | Sensor | | Power | | |
|---|---|---|---|---|---|---|
| | Accuracy | Cost | Sensor | (avg) milli- | | Field of |
| | in | ($each | Size | watts when | Range | View |
| Sensor | Steam | @1K) | (inAJ) | active) | (ft.) | (deg) |
| PIR | Poor | 4 | 1 | 5 | 30 | 15-110 |
| TOF | Poor | 3 | 0.1 | 20 | 3 | 25 |
| Ultrasonic | Good | 4 | 1 | 6 | 10 | 15 |

Now that the ultrasonic sensor technology has been identified as the ideal technology in a high steam environment, the next step is to test several models of sensors from different manufacturers to determine the best fit for this application.

Selecting a raw transducer element rather than a complete sensor will provide the lowest system cost, but will require more development effort to develop the sensor solution. The upside is that having complete control over the sensor design should allow the solution to be optimized for the cost, performance, power consumption, and form-factor criteria specific to this project.

### Ultrasonic Sensor Feasibility Testing

The Ultrasonic sensor was tested to meet key technical objectives: 1) the occupancy sensor must produce less than 1 “error” per 1000 trials in a high steam environment, and 2) an “error” of either:
a. —False Positive—Falsely reporting occupied when the shower stall is unoccupied, or
b. False Negative—falsely reporting unoccupied when the shower stall is occupied.

To assess the viability of the ultrasonic sensor for the shower stream application the following steps were taken:

1. Several waterproof ultrasonic transducers and sensors were selected from different manufacturers for evaluation. Select sensors based on range, field of view, cost, and operating temperature range. Select 5-10 sensors for evaluation.

2. The range, resolution, field of view, repeatability, immunity to steam, immunity to external audible noise, sensitivity to temperature, sensitivity to water spray, and power consumption of the sensor candidates was tested.

3. The sensor interface circuit was optimized for performance, power consumption and cost.

4. The firmware was optimized for performance and power consumption.

5. Several possible mounting configurations for the sensor in the Shower Stream product were tested (e.g. above the nozzle, below the nozzle, sensor flush with enclosure, sensor internal to enclosure bonded to enclosure surface, etc.).

6. Sensor performance was tested in different shower configurations.

7. The integrated prototype was subjected to waterproofing tests by submerging the entire device in water to ensure the enclosure is water proof.

We claim:

1. A smart showerhead adapter is configured to reduce the flow of water to 1% of the full flow rate by autonomously decreasing the area that the water flows through to 0.001 m̂2 by partially closing a magnetically-powered valve when a bather is determined to be in the 4″×4″×4″ shower stall area.

2. The adapter of claim 1 which includes a temperature sensor that measures a voltage relating to the temperature and sends an analog voltage signal to the computing block.

3. The adapter of claim 1 that reduces the flow of water once the water temperature reaches a steady state that is set by the user and is unique for each bathing experience.

4. The adapter of claim 1 that determines the occupancy of a shower stall by applying a detection algorithm to a doppler radar sensor which includes:
a. spatial radiated power control.
b. compensation for fundamental analog effects.
c. small radiated and consumed power.
d. using parasitic elements of a Printed Circuit Board (PCB) as part of the oscillator and matching components such as capacitors and inductors.
e. a directional antenna that radiates the EM wave at the oscillator frequency.
f. Includes a radio bit slicer

5. The doppler radar sensor of claim 4 that uses simple filtering and amplification techniques to create a low-frequency signal representing the reflected energy and speed of a moving object, presented to a processing element. The frequency content is below 30 Hz.

6. The adapter of claim 1 that wirelessly sends shower behavior data to an external web server via Wi-Fi, wherein the shower behavior data includes the amount of time that each shower takes, and the steady state temperature reached by the water.

7. The shower behavior data of claim 6 used to calculate the utility savings (reductions in water and energy costs) that are generated by the smart showerhead adapter.

8. The calculations for the utility savings of claim 7 that include the use of third-party data (e.g., prices from utility companies).

9. The adapter of claim 1 that communicates alerts to an external web server.
